(19) United States
(12) Patent Application Publication
(10) Pub. No.: US 2003/0000598 A1
(43) Pub. Date: Jan. 2, 2003

(54) Automatic effluence transfer system

(76) Inventors: Leon Han, San Jose, CA (US); Ted McGill, Cupertino, CA (US); Phyllis Han, San Jose, CA (US)

Correspondence Address: Chemflow Systems, Inc., Suite O, 1725 Rogers, Ave., San Jose, CA, 95112, US

(21) Appl. No.: 10/172,946

(22) Filed: Jun. 17, 2002

Related U.S. Application Data
(60) Provisional application No. 60/301,507, filed on Jun. 29, 2001.

(51) Int. Cl. B65B 3/04; B67C 3/00; B65B 1/04

(52) U.S. Cl. 141/319

(57) ABSTRACT

A automatic effluence transfer system for the transfer of effluences from a source container into a receiving reservoir comprises a receiving reservoir having a cover plate and a reservoir top opening, and a mechanism located above the receiving reservoir, which includes a pivot point, and an actuated force mechanism that would, once activated, automatically rotate and complete the pouring of source effluence into the receiving reservoir.

### FIELD OF THE INVENTION

This invention is related to an effluence transfer system. More specifically, this invention concerns an actuated, totally automatic system for the transfer, using a motor or pneumatic force, of a variety of effluences including, but not limited to, fluids, chemicals and flowable slurries.

### BACKGROUND OF THE INVENTION

The existence and operation of a wide variety of effluence transfer systems have been around for a long time. An example of a simple mechanical effluence transfer system is a hand-cranked pump to draw water from a source reservoir and transfer it to a receiving bottle. A second example of a totally sealed and sophisticated system for the transferring of hazardous chemical slurry from a mixing tank to a reactor module is an electronic-controlled peristaltic pump having automatic pressure and flow-sensors and using a totally sealed system of chemical-resistant piping. A third example is a mechanical Counter Balanced Chemical Transfer System that is now in use to safely transfer contains (chemicals or other effluents) in one gallon bottles. However, for the automatic transfer of effluence from containers, with capacity up to one or more gallons, into a receiving reservoir, there is a need of a simple automatic system that is safe, reliable and simple to operate.

### SUMMARY OF THE INVENTION

The first objective of this invention is to devise an automatic effluence transfer system, or AETS, that is automatic in its pouring operation.

The second objective of this invention is to provide for an AETS that is safe, reliable and simple to operate, keeping the operator or user of these chemicals safe from both chemical contact and, at the same time, avoid exposure to toxic fumes.

Other objectives, together with the foregoing are attained in the exercise of the invention in the following description and resulting in the embodiment illustrated in the accompanying drawings.

### BRIEF DESCRIPTION OF THE DRAWINGS

The current invention will be better understood and the nature of the objectives set forth above will become apparent when consideration is given to the following detailed description of the preferred embodiments. For clarity of explanation, the detailed description further makes reference to the attached drawings herein:

FIG.-1 illustrates a first top view of the current AETS in its initial starting state. The cover plate to the receiving reservoir is in closed position and a source container is inserted in the source container holder prior to starting the effluence transferring process;

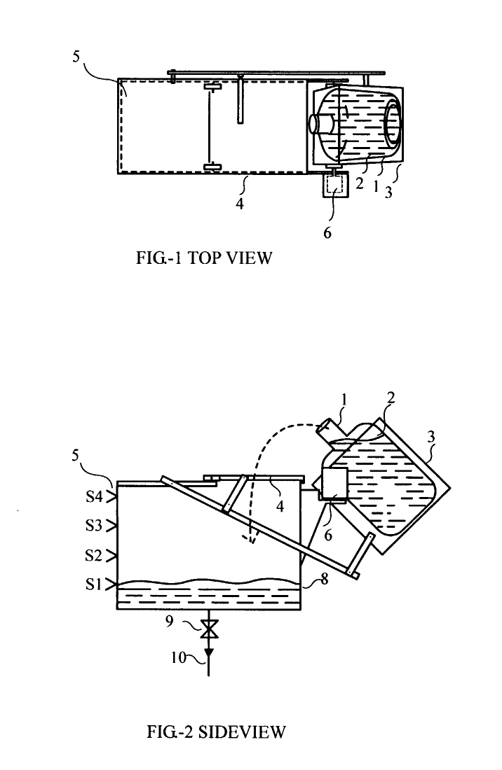

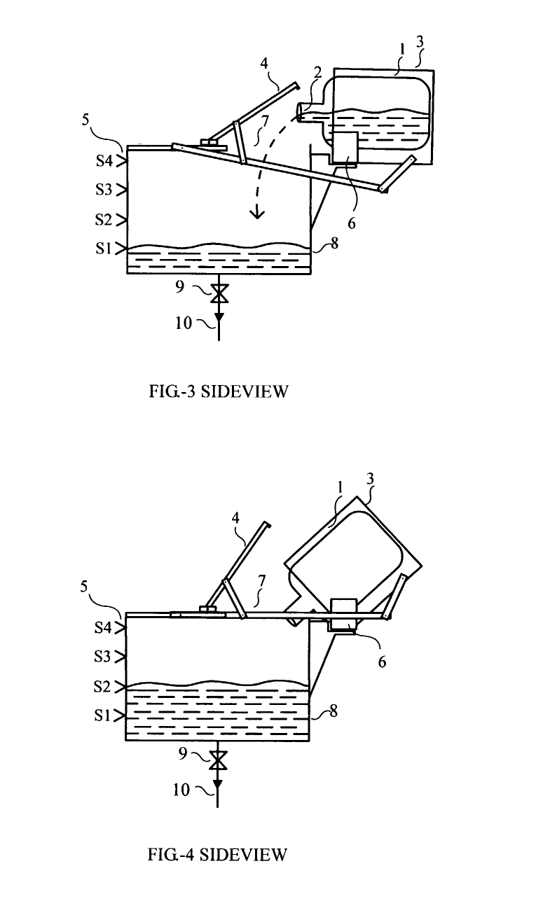

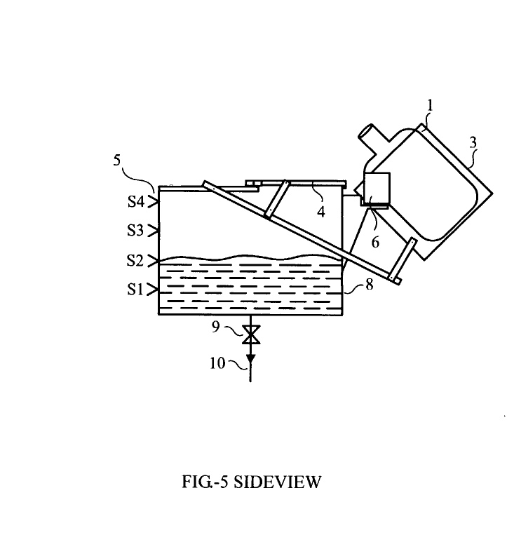

FIG.-2 illustrates a side view of part of the AETS in its initial starting state. FIG. 2 shows the source container holder with the bottle inserted at its lowest (starting) position. The internal effluent reservoir shows a lid on its top in the closed position. Functionality safety interlock features are integrated within the operation of the access (Containment Cabinet) doors and torque rotation device that do not allow the lid to open or the system (AETS) to be operated unless these interlock requirements are met.

FIG.-3 illustrates a second side view of the current AETS in a state wherein the interlocks have been met, i.e.; the door has been closed, and the actuation button pushed, and the effluence of the source container to be poured at a turned position that is at an approximate ninety-degree angle within the effluence transfer process. The reservoir lid is shown in the fully opened position that occurs in the initial start of the first forty-five degree turn. It is at this point in the middle of the effluence transferring process wherein the effluence of a source container has been partially transferred into a receiving reservoir by means of this AETS;

FIG.-4 illustrates a fourth side view of the current AETS at the end of the effluence transferring process wherein the effluence of a source container has been completely transferred into a receiving reservoir;

FIG.-5 illustrates a side view of the AETS wherein the source container holder has been returned to its initial state with the above mentioned reservoir lid assembly returned to closed position.

### DETAILED DESCRIPTION OF THE INVENTION

FIG.-1 Illustrates the top view of the AETS in its initial starting state. The source effluent 2 enclosed in the source container 1 is positioned at its lowest (starting) position. The cover plate 4 of the receiving reservoir is integrated with the source container 1 as such that in starting state, the cover plate 4 is in closed position.

FIG.-2 illustrates a first side view of the current AETS in its initial starting state wherein integral safety interlocking features are placed to prevent the starting of the effluence transferring process. Source effluence 2 enclosed inside source container 1, whose cap has previously been separately removed, is to be transferred into receiving reservoir 5 that is illustrated with an initial reservoir effluence level 8 at an elevation of S1. Additional elevations of the reservoir effluence level for future illustration are marked as S2, S3 and S4. For further usage of its effluence, receiving reservoir 5 is equipped with an output valve 9 and an output pipe 10. Source container 1 is removably held with a source container holder 3 that is linked to an actuation mechanism 6 that allows the source container 1 to rotate approximately one hundred and seventy degrees to empty the contents of the source container 1. Furthermore, the position and speed of the actuator 6 is preset for the rotation. The speed at which the actuator 6 rotates the source effluence 1 can be adjusted (programmed) accordingly for smooth transitions during pouring.

FIG.-3 illustrates a second side view of the AETS. The functionality of the above-mentioned integral safety interlocking features are integrated with the cover plate 4 of the receiving reservoir and source container holder 3. The cover plate 4 would either partially or completely cover up, from the top, a reservoir top opening 7 of the receiving reservoir 5. The system comprising the source container 1, the source effluence 2, the source container holder 3, the container holder 3 would immediately start a counterclockwise rotation around the pivot, resulting in the transfer of the desired effluence from the source container 1 into the receiving reservoir 5 via the reservoir top opening 7.

In the initial forty five degree counter clockwise rotation of the assembly, the cover plate 4 has completely cleared the reservoir top opening 7 of the receiving reservoir 5 for the receiving source effluence 2 from the source container 1. The upward swinging of the assembly comprising the source container 1 and the source container holder 3 from its initial starting position such that the out pouring of the source effluence 2 from the source container 1 into the now fully open reservoir top opening 7. In other words, the integral safety interlock features work to prevent any out pouring of the source effluence 2 from the source container 1 until the reservoir top opening 7 of the receiving reservoir 5 is fully exposed for the receiving source effluence 2.

Continuing the effluence transferring process, FIG.-3 and FIG.-4 illustrate side views of the present AETS where the source effluence 2 of the source container 1 has been partially transferred into the receiving reservoir 5. Notice that the system rotates counterclockwise until the completion of the transfer as shown in FIG.-4. This means that, due to the emptying of the source effluence 2 from the source container 1, the continuing counterclockwise rotation of the system could accelerate to a degree where the source effluence 2 has been completely emptied into the receiving reservoir 5 with a final reservoir effluence level 8 at an elevation of S2. The system will return the AETS to its initial state after a time delay to allow for complete drainage.

FIG.-5 illustrates a side view of the AETS returned to its initial stating state. At this time, the emptied source container 1 can be replaced with another one and the whole effluence transfer process repeated again.

As described, a specific set of embodiments of the automated effluence transfer system, or AETS, and associated methods of operation have been described for the automatic transferring of effluence from a source container into a receiving reservoir. The invention has been described using exemplary preferred terms. However, for those skilled in this field, the preferred embodiments of these terms can be easily adapted and modified to suit additional applications without departing from the spirit and scope of this invention. Thus, it is to be understood that the scope of the invention is not limited to the disclosed embodiments. On the contrary, it is intended to cover various modifications and similar arrangements based upon the same operating principle. The scope of the claims, therefore, should be accorded the broadest interpretations so as to encompass all such modifications and similar arrangements.

We claim:

1. An automatic effluence transfer system for safe automatic transferring of effluences from a source container into a receiving reservoir comprising:
a receiving reservoir comprising a cover plate and a reservoir top opening for receiving an effluence; a pivot point with bearing; an effluence transfer process whereby the source effluence enclosed in said source container will be completely poured into said receiving reservoir.

2. The automated effluence transfer system as stated in claim 1 further comprises a safety interlock means such that, unless the receiving reservoir cover plate is pushed to completely expose the reservoir top opening, the safety interlock features will block the AETS from any movement thus preventing the start up of the effluence transfer process.
